(19) United States
(12) Patent Application Publication
(10) Pub. No.: US 2010/0224551 A1
(43) Pub. Date: Sep. 9, 2010

(54) MICRO FLUIDIC DEVICE, SEPARATION METHOD AND SEPARATION APPARATUS

(75) Inventors: Kazuya Hongo, Kanagawa (JP); Hiroshi Kojima, Kanagawa (JP); Tetsuo Ohta, Kanagawa (JP); Seiichi Takagi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/553,459

(22) Filed: Sep. 3, 2009

(30) Foreign Application Priority Data
Mar. 3, 2009 (JP) 2009-048893

(51) Int. Cl. B01D 35/30

(52) U.S. Cl. 210/454

(57) ABSTRACT

A micro fluidic device includes a separation membrane that has an upper surface and a lower surface opposing to each other and a side surface; a plurality of base materials that sandwiches the separation membrane; a first channel and a second channel that are partitioned from each other by the separation membrane; a first feed port that is connected to the first channel; and a first discharge port that is connected to the second channel, wherein the first channel comes into contact with at least a part of the upper surface and the lower surface of the separation membrane, the second channel comes into contact with at least a part of the side surface of the separation membrane, and a fluid is movable in a surface direction within the separation membrane.

### CROSS-REFERENCE TO RELATED APPLICATION

This application is based on and claims priority under 35 USC 119 from Japanese Patent Application No. 2009-048893 filed on Mar. 3, 2009.

### BACKGROUND

TECHNICAL FIELD

The present invention relates to a micro fluidic device, a separation method and a separation apparatus.

### SUMMARY

According to an aspect of the invention, a micro fluidic device includes a separation membrane that has an upper surface and a lower surface opposing to each other and a side surface; a plurality of base materials that sandwiches the separation membrane; a first channel and a second channel that are partitioned from each other by the separation membrane; a first feed port that is connected to the first channel; and a first discharge port that is connected to the second channel, wherein the first channel comes into contact with at least a part of the upper surface and the lower surface of the separation membrane, the second channel comes into contact with at least a part of the side surface of the separation membrane, and a fluid is movable in a surface direction within the separation membrane.

### BRIEF DESCRIPTION OF THE DRAWINGS

Exemplary embodiments of the invention will be described in detail based on the following figures, wherein:

FIG. 1 is a schematic sectional view showing an embodiment of a micro fluidic device of the present exemplary embodiment;

FIG. 2 is a schematic sectional view showing other embodiment of a micro fluidic device of the present exemplary embodiment;

FIG. 3 is a schematic sectional view showing a further other embodiment of a micro fluidic device of the present exemplary embodiment;

FIG. 4 is a schematic sectional view showing a further other embodiment of a micro fluidic device of the present exemplary embodiment;

FIG. 5 is a schematic sectional view showing a further other embodiment of a micro fluidic device of the present exemplary embodiment;

FIG. 6 is a schematic sectional view cut along an a₁-a₁ plane going through a central portion of the micro fluidic device shown in FIG. 5;

FIG. 7 is a schematic sectional view cut along a b₁-b₁ plane going through a discharge port Y₂ 34 of the micro fluidic device shown in FIG. 5;

FIG. 8 is a schematic view showing a further other embodiment of a micro fluidic device of the present exemplary embodiment;

FIG. 9 is a schematic view showing a further other embodiment of a micro fluidic device of the present exemplary embodiment;

FIG. 10 is a schematic sectional view cut along an a₂-a₂ plane going through a central portion of the micro fluidic device shown in FIG. 8;

FIG. 11 is a schematic sectional view cut along a b₂-b₂ plane going through a discharge port Y₁ 32 of the micro fluidic device shown in FIG. 8;

FIG. 12 is a conceptual view of an embodiment of a separation apparatus of the present exemplary embodiment;

FIG. 13A is a schematic view showing an upper surface of a part of a porous film 500 of a separation membrane (honeycomb film) in an example;

FIG. 13B is a schematic view of a b-b section in FIG. 13A;

FIG. 13C is a schematic view of a c-c section in FIG. 13A;

FIG. 14 is a view showing a recessed pattern of a PMMA-made chip fabricated in Comparative Example 1; and

FIG. 15 is an exploded schematic view of a section of acrylic resin plate fabricated in Comparative Example 2.

### DETAILED DESCRIPTION

The present exemplary embodiment is hereunder described in detail.

In the present exemplary embodiment, the terms “from (numerical value A) to (numerical value B)” mean not only a range between A and B but a range including A and B as the both ends. For example, if the “from A to B” is a numeral range, it means “A or more and not more than B” or “B or more and not more than A”.

A micro fluidic device of the present exemplary embodiment includes a separation membrane having an upper surface and a lower surface opposing to each other and a side surface; plural of base materials sandwiching the separation membrane; a channel L₁ and a channel L₂ which are partitioned from each other by the separation membrane; a feed port X₁ connected to the channel L₁; and a discharge port Y₁ connected to the channel L₂, wherein the channel L₁ comes into contact with at least a part of the upper surface and/or the lower surface of the separation membrane, the channel L₂ comes into contact with at least a part of the side surface of the separation membrane, and a fluid is movable in a surface direction within the separation membrane.

The micro fluidic device of the present exemplary embodiment may be suitably applied as separation means in a separation method and a separation apparatus.

As in the invention disclosed in JP-A-2006-61870, in the case where during the separation and concentration of a particle from a particle dispersion, a separation membrane having a thin thickness and a small pore size is repeatedly used several times using a micro device obtained by sandwiching and bonding a separation membrane having a thin thickness with base materials each having a channel formed therein, the separation membrane is easily broken because of its low strength.

Also, as disclosed in JP-A-2006-95515, in the case where during the separation and concentration by a method in which by using a micro device obtained by sandwiching and bonding a separation membrane with base materials in which recessed parts serving as an upstream side bath and a downstream side bath are formed on the same base material, a fluid moves in a surface direction in the separation membrane, for example, the separation membrane is used so as to come into contact with the recessed pattern, in order that the particle which has passed once through an upper part of the minute separation membrane and entered the separation membrane may be discharged into a channel on the downstream side, they again pass through the upper part of the separation membrane, and the particle is easy to remain within the separation membrane without being discharged into the channel on the downstream side. Thus, clogging is caused, a pressure loss is large, and the efficiency is lowered.

On the other hand, in the micro fluidic device of the present exemplary embodiment, a fluid may move in the surface direction of a separation membrane in the inside of the membrane, and a channel for recovering a separation membrane-passed liquid (channel L₂) in the surroundings of the side surface part of the separation membrane such that the fluid is discharged from the side surface part of the separation membrane. Thus, the micro fluidic device of the present exemplary embodiment is excellent in durability of a separation membrane and excellent in separation efficiency.

Also, in the micro fluidic device of the present exemplary embodiment, a micro field is utilized, and a fluid moves in the inside of the separation membrane. Therefore, even in case of using a separation membrane with low strength, it may be estimated that the micro fluidic device of the present exemplary embodiment is excellent in durability of the separation membrane, large in a specific area effect of the separation membrane and remarkably high in separation efficiency.

Furthermore, a micro field is utilized; the separation membrane is sandwiched with plural of base materials; the fluid does not directly pass from the upper surface to the lower surface or from the lower surface to the upper surface of the separation membrane; and a large force is not applied to the membrane direction with low strength. Therefore, it may be estimate that the separation membrane is hardly damaged.

Also, an opening ratio of the separation membrane may be increased to the limit, and therefore, it may be estimated that a pressure loss is extremely small, and it may be contrived to maximize the treatment amount. For example, in the case where the pore size of the separation membrane is identical, as the number of pores increases, the opening ratio increases, and the treatment amount also increases. However, the strength of the separation membrane remarkably decreases, and therefore, the prior-art methods involved a limit in view of the durability. On the other hand, according to the micro fluidic device of the present exemplary embodiment, a separation membrane having a largely increased opening ratio may be used, and both an increase of the treatment amount and durability may be made compatible with each other.

The micro fluidic device of the present exemplary embodiment is a micro fluidic device for separation and concentration having at least plural of micro-scale channels having a width of, for example, several μm to several thousand μm.

In the micro fluidic device of the present exemplary embodiment, the “micro-scale channel” refers to a channel having a channel diameter of not more than 5,000 μm. The “channel diameter” is a circle-corresponding diameter determined from a sectional area of the channel.

As to the micro-scale channel, a device having a channel diameter of from several μm to several thousand μm is preferably used. The channel diameter of the micro channel of the device is preferably from 10 to 5,000 μm, and more preferably from 20 to 3,000 μm.

The micro-scale channel is small in all of a dimension and a flow rate, and its Reynolds number is not more than 2,300.

Accordingly, the micro fluidic device having a micro-scale channel is not a device which is governed by a turbulent flow as in usual reactors but a device which is governed by a planar flow.

Here, the Reynolds number (Re) is represented by the following expression, and when the Reynolds number (Re) is not more than 2,300, the micro fluidic device is governed by a laminar flow.

Re=uL/ν

In the foregoing expression, u represents a flow velocity; L represents a representative length; and ν represents a coefficient of kinematic viscosity.

In the micro fluidic device of the present exemplary embodiment, though the length of the channel is not particularly limited, it is preferably in the range of from 5 to 300 mm, and more preferably in the range of from 10 to 200 mm.

Though the sectional shape of the channel in the micro fluidic device of the present exemplary embodiment is not particularly limited, it may be properly chosen among a circular shape, an elliptical shape, a bell-like shape and the like depending upon the purpose. Of these, the sectional shape of the micro channel is preferably a circular shape, an elliptical shape or a rectangular shape, and more preferably a circular shape or a rectangular shape.

Also, the channel in the micro fluidic device of the present exemplary embodiment may have branching, and for example, the channel may have a doughnut shape on the way.

The micro fluidic device of the present exemplary embodiment may be suitably used as a micro fluidic device for separation, may be more suitably used as a micro fluidic device for separating a particle, and may be further suitably used as a micro fluidic device for separating a particle having a particle size of from 0.01 to 500 μm.

Needless to say, the “separation” in the present exemplary embodiment includes classification and concentration.

Though a size of the micro fluidic device may be properly set up depending upon the use purpose, it is preferably in the range of from 1 to 500 cm², and more preferably in the range of from 10 to 300 cm².

Also, a thickness of the micro fluidic device is preferably in the range of from 2 to 50 mm, and more preferably in the range of from 3 to 30 mm.

The separation membrane which may be used for the micro fluidic device of the present exemplary embodiment is not particularly limited so far as it has an upper surface and a lower surface opposing to each other and a side surface, and a fluid may move in a surface direction of the membrane within the separation membrane, and known separation membranes are useful.

Specific examples of the separation membrane which may be used include various separation membranes having an opening in a side surface direction thereof, for example, mesh-shaped separation membranes woven with plastic fibers or metallic fibers, plastic-made honeycomb films by self organization, ceramic-made separation membranes, paper-made separation membranes, etc. In particular, for the purpose of efficiently achieving the treatment, it is preferred to use a separation membrane with a high opening ratio.

Examples of the honeycomb film include resin-made films with a high opening ratio disclosed in JP-A-2001-157574, JP-A-2005-262777, JP-A-2007-269923, etc.

In case of using a separation membrane having elasticity and high adhesiveness such as rein-made honeycomb films, a device obtained by sandwiching the separation membrane between two substrates and fixing them by fastening using a fixing tool or the like may be suitably used as the micro fluidic device of the present exemplary embodiment.

A material of the separation membrane which may be used in the present exemplary embodiment is not particularly limited, and examples thereof include plastics, ceramics, fibers, papers and metals. Of these, plastics are especially preferable. Also, as the plastics which may be used as a material of the separation membrane, polycarbonates, polyamides, polysulfones, polystyrenes, polymethyl methacrylate, ultraviolet ray curable resins, polydimethylsiloxane, polyphenylmethylsiloxane, epoxy resins, Teflon (a registered trademark), polyimides and the like may be preferably exemplified from the standpoint of strength.

Also, in the separation membrane, it is preferable that of the upper surface and the lower surface, the surface through which a fluid passes is free from irregularities; and it is more preferable that the upper surface and the lower surface are free from irregularities.

Also, the shape of the separation membrane is not particularly limited, and a separation membrane having the desired shape in the micro fluidic device may be used. Specifically, for example, a membrane having, as a sectional shape in the surface direction of the membrane, a polygonal shape, a circular shape or an elliptical shape or an amorphous membrane may be used.

In the separation membrane which may be used in the present exemplary embodiment, it is preferable that the side surface of the membrane has a larger average pore size than the upper surface and/or the lower surface of the membrane through which a fluid passes.

Also, an opening ratio of the separation membrane which may be used in the present exemplary embodiment is preferably from 5 to 95%, and more preferably from 20 to 80%.

An average pore size of the separation membrane which may be used in the present exemplary embodiment is preferably from 0.1 to 200 μm, more preferably from 0.1 to 50 μm, and further preferably from 0.5 to 50 μm.

Though a thickness of the separation membrane which may be used in the present exemplary embodiment is not particularly limited, it is preferably thicker than the average pore size of the separation membrane, more preferably from 0.1 to 2 mm, and further preferably from 0.1 to 200 μm.

A shape of the separation membrane is not particularly limited, and examples thereof include a circular shape, an elliptical shape and a polygonal shape. Of these, a circular shape, a quadrilateral shape, a triangular shape and/or a hexagonal shape is preferable.

A shape pattern of the pore of the separation membrane is not particularly limited, and examples thereof include patterns in which circles, ellipses, polygons or the like are arranged. For example, a shape pattern of a circular pore as in a separation membrane shown in FIG. 11 may be suitably exemplified.

The micro fluidic device of the present exemplary embodiment at least has two or more base materials for sandwiching the separation membrane.

The number of base materials in the micro fluidic device of the present exemplary embodiment is not particularly limited so far as it is 2 or more. From the viewpoint of manufacture, the number of base materials is preferably from 2 to 20 and more preferably from 2 to 10.

A shape of the base material in the micro fluidic device of the present exemplary embodiment is not particularly limited but may be any arbitrary shape. For example, a channel or an installation position of the separation membrane may be formed by forming a recessed part or a through-hole on the base material; or a channel or an installation position of the separation membrane may be formed by combining plural of base materials having a shape of rectangular parallelepiped.

As a material of the micro fluidic device of the present exemplary embodiment, generally used materials, for example, metals, ceramics, plastics, glasses, etc. are useful, and it is preferred to properly choose the material depending upon a medium liquid to be sent. As a channel shape of the micro fluidic device, arbitrary shapes whose section is a rectangular form such a rectangle and a cube, a circular form, an elliptical form, etc. are useful. Also, in case of a rectangular shape, a size of the channel is of a milli-scale or a micro-scale, and a channel width is preferably not more than 10 mm, more preferably in the range of from 0.01 to 5 mm, and further preferably in the range of from 0.03 to 2 mm.

Also, as to a material of the base material in the micro fluidic channel device of the present exemplary embodiment, only one kind may be used, or two or more kinds may be used jointly.

The micro fluidic device of the present exemplary embodiment may be fabricated by processing a material of the base material by known processing technologies.

Also, the base material which is used for the micro fluidic device of the present exemplary device may also be fabricated by processing a material of the base material by the following microfabrication technology.

Examples of the microfabrication technology which may be adopted include methods described in, for example, Micro-Reactor: Synthetic Technology for New Era (issued in 2003 by CMC Publishing Co., Ltd. and compiled by Yoshida, Junichi) and Microfabrication Technology, Applied Edition: Application to Photonics, Electronics and Mechatronics (published in 2003 by NTS Inc., edited by Event Committee of The Society of Polymer Science, Japan).

Representative examples of the method include an LIGA technology using X-ray lithography, a high-aspect ratio photolithography method using EPON SU-8, a micro discharge processing method (μ-EDM), a high-aspect ratio processing method of silicon by Deep RIE, a hot emboss processing method, a photo-fabrication method, a laser processing method, an ion beam processing method and a mechanical micro cutting processing method using a micro tool made of a hard material such as diamond. These technologies may be adopted singly or in combination. Preferred microfabrication methods are an LIGA technology using X-ray lithography, a high-aspect ratio photolithography method using EPON SU-8, a micro discharge processing method (μ-EDM) and a mechanical micro cutting processing method.

The channel which is used in the present exemplary embodiment may also be fabricated by using, as a casting mold, a pattern formed on a silicon wafer using a photoresist, casting a resin thereinto and solidifying it (molding method). For the molding method, silicon resins represented by polydimetlylsiloxane (PDMS) or derivatives thereof may be used.

Also, in manufacturing the micro fluidic device of the present exemplary embodiment, a method for bonding or fixation between a base material and a base material is not particularly limited, and known bonding technologies or fixation technologies may be adopted.

As to the bonding method which is generally adopted, examples of solid phase bonding include pressure welding and diffusion bonding; and examples of liquid phase bonding include welding, eutectic bonding, soldering and adhesion.

Also, the fixation method is not particularly limited, and known fixation methods may be adopted for achieving fixation. Examples thereof include a method for achieving fixation using a known fixing member such as fastening parts, for example, a bolt, a nut, etc. and fixing tools.

Furthermore, in achieving bonding, a high precise bonding or fixation method while keeping a dimensional precision, which is not accompanied with breakage of a micro structure of a channel, etc. to be caused by degeneration or deformation upon high-temperature heating, is preferable. Examples of technologies thereof include silicon direct bonding, anodic bonding, surface activation bonding, direct bonding using a hydrogen bond, bonding using an HF aqueous solution, Au—Si eutectic bonding, void-free adhesion, fixation with a bolt and fixation with a fixing tool.

In the micro fluidic device of the present exemplary embodiment, for the purposes of preventing liquid leakage from a bonding or fixing portion between the base materials and enhancing airtightness, known sealing members such as packings, for example, an O-ring, etc., gaskets and sealing agents may be used.

Also, the O-ring is a sealing member having a section of an O-type ring, and as to a material thereof, synthetic rubber based materials such as nitrile rubbers, styrene rubbers, silicone rubbers and fluorocarbon rubbers, plastic based materials such as polyamide resins, fluorocarbon resins and phenol resins, metallic materials and the like may be used. Of these, O-rings made of a rubber based material which may flexibly respond to the shape of the device channel are preferable.

The micro fluidic device of the present exemplary embodiment includes at least a channel L₁ and a channel L₂ which are partitioned from each other by the separation membrane.

The channel L₁ is connected to a feed port X₁ and comes into contact with at least a part of the upper surface and/or the lower surface of the separation membrane. At the time of using the micro fluidic device of the present exemplary embodiment, a fluid which has not passed through the separation membrane is sent to the channel L₁.

A part of the channel L₁ may come into contact with either one of the upper surface or the lower surface of the separation membrane. Also, a part of the channel L₁ may come into contact with both of the upper surface and the lower surface of the separation membrane. Also, it is preferable that the channel L₁ comes into contact with a part of the upper surface and/or the lower surface of the separation membrane.

In the micro fluidic device of the present exemplary embodiment, a fluid which has entered the separation membrane from the upper surface and/or the lower surface of the separation membrane does not go straight as it is to flow out from the lower surface and/or the upper surface, but a fluid which has entered the separation membrane flows in the surface direction of the separation membrane and is discharged chiefly from the side surface of the separation membrane.

Also, the micro fluidic device of the present exemplary embodiment is preferably a device in which the whole of a fluid which has passed through the separation membrane is discharged from the side surface of the membrane.

Also, in the micro fluidic device of the present exemplary embodiment, in the case where the channel L₁ comes into contact with the upper surface and the lower surface of the separation membrane, it is preferable that positions of the upper surface and the lower surface of the separation membrane with which the channel L₁ comes into contact are deviated from a vertical position relative to the surface direction of the separation membrane.

The channel L₂ is connected to a discharge port Y₁ and comes into contact with at least a part of the side surface of the separation membrane. At the time of using the micro fluidic device of the present exemplary embodiment, a fluid which has passed through the separation membrane is sent to the channel L₁.

In case of achieving separation using the micro fluidic device of the present exemplary device, a fluid containing a material to be separated is sent to the channel L₁ from the feed port X₁ and flows into the separation membrane from the upper surface and/or the lower surface of the separation membrane. Thereafter, the fluid which has flown into the separation membrane moves in the surface direction within the separation membrane and flows into the channel L₂, and it is then discharged from the discharge port Y₁.

In passing through the upper surface and/or the lower surface of the separation membrane, and/or in moving in the surface direction within the separation membrane, the material to be separated is subjected to separation (including concentration, classification, etc.).

Needless to say, in using the micro fluidic device of the present exemplary embodiment, for the purpose of cleaning the micro fluidic device, a fluid may be sent from the discharge port Y₁ and discharged from the feed port X₁.

It is preferable that in the channel L₁, at least a part of the portion coming into contact with the separation membrane has a portion where a fluid flows in parallel to the upper surface or the lower surface of the contacting separation membrane with which the part of the channel L₁ comes into contact.

In the micro fluidic device of the present exemplary embodiment, it is preferable that the channel L₁ comes into contact with at least a part of the upper surface or the lower surface of the separation membrane and that of the upper surface and the lower surface of the separation membrane, the opposite surface to the surface with which the channel L₁ comes into contact is blocked.

The blocked portion in the opposite surface to the surface with which the channel L₁ comes into contact may be a portion of the opposite surface corresponding to the portion with which the channel L₁ comes into contact and its neighborhood, or may be the whole of the opposite surface. However, from the viewpoint of durability of the separation membrane, it is more preferable that the whole of the opposite surface is blocked.

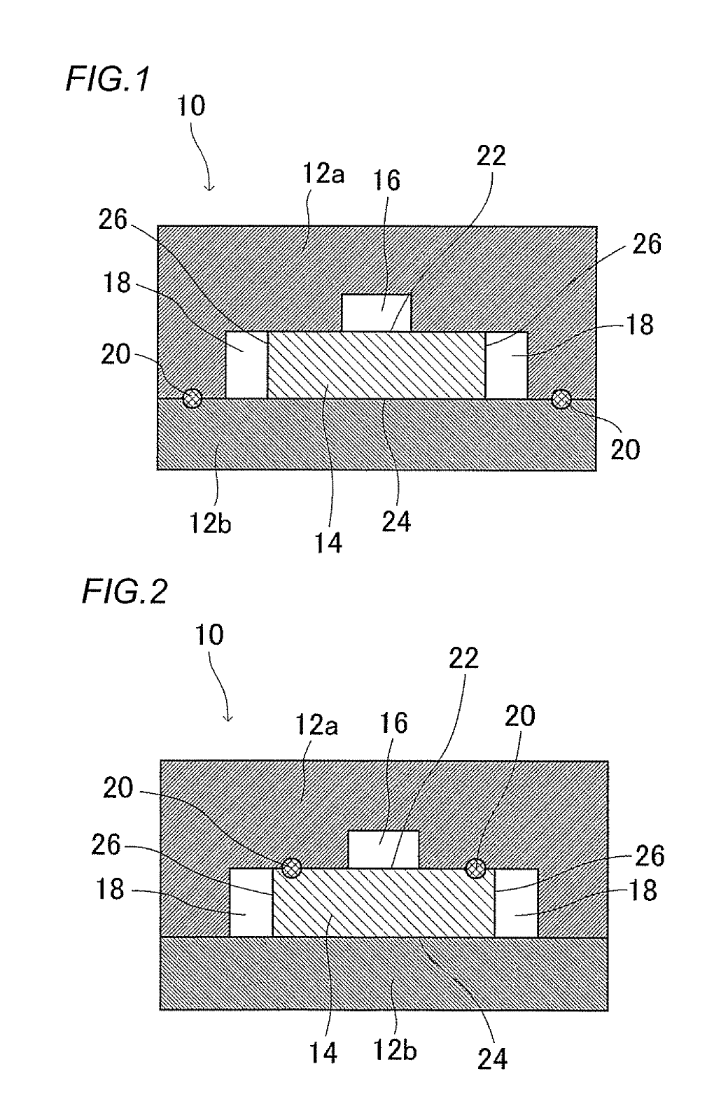

As the micro fluidic device of the present exemplary embodiment in which the channel L₁ comes into contact with at least a part of the upper surface or the lower surface of the separation membrane, and of the upper surface and the lower surface of the separation membrane, the opposite surface to the surface with which the channel L₁ comes into contact is blocked, specifically, for example, micro fluidic devices shown in FIGS. 1 to 9 as described later may be suitably exemplified.

The micro fluidic device of the present exemplary embodiment may include one or more other channels than the channel L₁ and the channel L₂, if desired.

Also, the micro fluidic device of the present exemplary embodiment may include one or more other feed ports than the feed port X₁ and one or more other discharge ports than the discharge port Y₁, if desired.

Also, in the micro fluidic device of the present exemplary embodiment, the feed port and the discharge port are not specifically required to be different from each other in terms of the shape. The feed port and the discharge port may have an opening of the same shape or may have an opening of a different shape from each other.

In the micro fluidic device of the present exemplary embodiment, it is preferable that a discharge port Y₂ is further connected to the channel L₁. When the discharge port Y₂ is connected to the channel L₁, a material to be separated which has not passed through the separation membrane may be easily recovered, and the micro fluidic device may be used over a long period of time. Also, when the feed port X₁ and the discharge port Y₂ are connected to each other in the outside of the micro fluidic device, circulation of a fluid containing a material to be separated may be achieved, and separation efficiency may be enhanced.

In the micro fluidic device of the present exemplary embodiment, it is preferable that a feed port X₂ is further connected to the channel L₂. When the feed port X₂ is connected to the channel L₂, in using as a separation apparatus, a fluid may be sent from the feed port X₂ without changing a connection structure between the micro fluidic device and the outside, thereby easily achieving cleaning of the micro fluidic device or dissolution of clogging or the like.

In the micro fluidic device of the present exemplary embodiment, the separation membrane may be a laminated separation membrane obtained by laminating two or more membranes.

As to the membrane of the laminated separation membrane, in a membrane coming into contact with the channel L₁, a fluid may move at least in the surface direction of the membrane. However, it is preferable that in all of membranes, a fluid may move in the surface direction of the membrane.

The shape, thickness, average pore size, pore shape, shape pattern and the like of the membrane in the laminated separation membrane are the same as those in the foregoing separation membrane. Preferred ranges thereof are also the same.

Two or more membranes of the laminated separation membrane may be an identical membrane or may be a membrane which is different in the shape and material and the like. In case of using two or more different membranes, the lamination order may be properly chosen depending upon the purpose and an application.

In the laminated separation membrane, membranes may be adhered to each other, or two or more membranes may be simply sandwiched with plural of base materials without being adhered to each other.

The micro fluidic device of the present exemplary embodiment may include other minute channels and sites having a function such as reaction, mixing, purification, analysis and cleaning, in addition to the foregoing channels, separation membrane, feed ports and discharge ports, depending upon an application.

A separation apparatus of the present exemplary embodiment is a separation apparatus provided with the micro fluidic device of the present exemplary embodiment.

A separation method of the present exemplary embodiment is a separation method of using the micro fluidic device of the present exemplary embodiment and preferably includes a step of sending a fluid to the channel L₁ and a step of recovering the fluid which has passed through the separation membrane from the discharge port Y₁ connected to the channel L₂.

Also, it is preferable that the separation method of the present exemplary embodiment uses the separation apparatus of the present exemplary embodiment.

Also, in the separation apparatus and the separation method of the present exemplary embodiment, the separation apparatus may be suitably constructed by combining plural of the micro fluidic devices of the present exemplary embodiment, or by combining the micro fluidic device of the present exemplary embodiment with an apparatus having a function such as reaction, mixing, separation, purification, analysis and cleaning, a liquid sending apparatus, a recovery apparatus, other micro fluidic device, etc., depending upon an application.

The material to be separated in the separation apparatus or the separation method of the present exemplary embodiment is not particularly limited so far as it may be separated by the micro fluidic device of the present exemplary embodiment. The separation apparatus or the separation method of the present exemplary embodiment may be suitably used as a classification apparatus or a separation method of a particle. Also, the separation apparatus or the separation method of the present exemplary embodiment is suitable as a classification apparatus or a separation method for feeding a particle dispersion from the feed port X₁ and discharging a classified particle from the discharge port Y₁.

The particle to be classified is not particularly limited and may be an inorganic particle or an organic particle or a mixture thereof.

A particle size of the particle is preferably 0.01 μm or more and not more than 500 μm, and more preferably 0.1 μm or more and not more than 200 μm. Glen the particle size falls within the foregoing range, clogging of the channel may be prevented from occurring, and good classification efficiency may be attained. Also, attachment of the particle to an inner wall of the channel is hardly caused.

Though a shape of the particle is not particularly limited, a ratio of a long axis length to a short axis length of the particle ((long axis length)/(short axis length)) is preferably in the range of from 1 to 50, and more preferably in the range of from 1 to 20. Also, it is preferred to properly choose a width of the channel in conformity with the particle size and the particle shape.

As to the kind of the particle which is used in the separation apparatus or the separation method of the present exemplary embodiment, those enumerated below are useful, but it should not be construed that the invention is limited thereto. Examples thereof include a polymer particle (resin particle), a crystal or an aggregate of an organic material such as pigments, a crystal or an aggregate of an inorganic material, a metallic particle and a particle of a metallic compound such as metal oxides, metal sulfides and metal nitrides. Also, there is exemplified a particle of a rubber, a wax (granular wax), a hollow particle, etc.

Specific examples of the polymer particle include particles of a polyvinyl butyral resin, a polyvinyl acetal resin, a polyallylate resin, a polycarbonate resin, a polyester resin, a phenoxy resin, a polyvinyl chloride resin, a polyvinylidene chloride resin, a polyvinyl acetate resin, a polystyrene resin, an acrylic resin, a methacrylic resin, a styrene-acrylic resin, a styrene-methacrylic resin, a polyacrylamide resin, a polyamide resin, a polyvinylpyridine resin, a cellulose based resin, a polyurethane resin, an epoxy resin, a silicone resin, a polyvinyl alcohol resin, a casein, a vinyl chloride-vinyl acetate copolymer, a modified vinyl chloride-vinyl acetate copolymer, a vinyl chloride-vinyl acetate-maleic anhydride copolymer, a styrene-butadiene copolymer, a vinylidene chloride-acrylonitrile copolymer, a styrene-alkyd resin, a phenol-formaldehyde resin, etc.

Also, examples of the particle of a metal or a metallic compound include particles of carbon black, a metal (for example, zinc, aluminum, copper, iron, nickel, chromium, titanium, etc.) or an alloy thereof, a metal oxide (for example, TiO₂, SnO₂, Sb₂O₃, In₂O₃, ZnO, MgO, iron oxide, etc.) or a compound thereof, a metal nitride (for example, silicon nitride, etc.), etc. or a combination thereof.

As the particle of a rubber, those obtained by atomizing a nitrile rubber, a styrene rubber, an isobutylene rubber, etc. are useful. The atomization may be carried out by emulsion polymerization or in a mechanical manner such as refrigeration and cooling pulverization.

As the granular wax, those obtained by atomization by any one of known methods using an emulsification and dispersion instrument, etc. described in Report 1 from Research Group of Reaction Engineering of The Society of Polymer Science, Japan, “Emulsification and dispersion technology and particle size control of polymer fine particles; Chapter 3”, published in March 1995 are useful.

Also, as the granular wax, fine particle waxes (mold releasing agents) obtained by a method in which a mold releasing agent is added to an appropriate solvent which is compatible at the time of heating and does not dissolve the mold releasing agent therein at room temperature and dissolved by heating, and the solution is then gradually cooled to room temperature, thereby depositing a fine particle of the mold releasing agent (dissolution and deposition method) or a method in which a mold releasing agent is heated and evaporated in an inert gas such as helium to prepare a particle in a vapor phase, this particle is allowed to attach to a cooled film or the like and recovered, and the recovered particle is then dispersed in a solvent (vapor phase evaporation method) are useful. In the preparation of the foregoing fine particle wax, the particle may be further atomized by a combination with a mechanical pulverization method using a medium or the like.

Examples of a resin which is a raw material of the granular wax include, in addition to low molecular weight polypropylene and low molecular weight polyethylene, waxes such as vegetable waxes (for example, carnauba wax, cotton wax, Japan wax, rice wax, etc.), animal waxes (for example, beeswax, lanolin, etc.), mineral waxes (for example, ozokerite, cercine, etc,) and petroleum waxes (for example, paraffins, microcrystalline, petrolactam, etc.). Also, in addition to these natural waxes, there are exemplified synthetic hydrocarbon waxes such as Fischer-Tropsch wax. Of these, low molecular weight polypropylene, low molecular weight polyethylene, carnauba wax and paraffins are preferable as the resin which is a raw material of the granular wax.

As the hollow particle, inorganic or organic hollow particles may be used. As the inorganic hollow particle, silica based and silica/alumina based hollow particles are preferable; and as the organic hollow particle, resin based hollow particles are preferable. Also, the number of a void within the particle may be single or plural. Though a percentage of void is not particularly limited, it is preferably from 20% to 80%, and more preferably from 30% to 70%. Specifically, examples of the inorganic hollow particle include FELLITE, manufactured by Japan Fillite Co., Ltd. and CENOLITE, manufactured by Tomoe Engineering Co., Ltd.; and examples of the organic hollow particle include EXPANCEL, manufactured by Japan Fillite Co., Ltd., ADVAN CELL, manufactured by Sekisui Chemical Co., Ltd., SC866(A) and SX866(B), manufactured by JSR Corporation and NIPOL MH5055, manufactured by Zeon Corporation. Of these, EXPANCEL, manufactured by Japan Fillite Co., Ltd. is preferably used as the hollow particle. In particular, a thermally expandable particle such as EXPANCEL DU is used upon being expanded to a desired size by appropriate heating.

Furthermore, the manufacturing method of such a particle is widely divergent. A fine particle may be prepared in a liquid medium by means of synthesis and classified as it is, or a particle prepared by mechanically pulverizing a massive material may be dispersed in a liquid medium. In that case, in many cases, the massive material is pulverized in a liquid medium and classified as it is.

On the other hand, in case of classifying a particle (powder) prepared in a dry manner, it is necessary to previously disperse the dry powder in a liquid medium. Examples of a method for dispersing the dry powder in a medium include those using a sand mill, a colloid mill, an attritor, a ball mill, a Dyno-Mill, a high pressure homogenizer, an ultrasonic dispersion machine, a Coball-Mill, a roll mill, etc. On that occasion, it is preferable that dispersion is carried out under a condition under which a primary particle is not pulverized by dispersion.

In the present exemplary embodiment, a content of the particle in the fluid is preferably from 0.001 to 40% by volume, and more preferably from 0.01 to 25% by volume. Wien the content of the particle is 0.001% by volume, recovery is good, and when it is not more than 40% by volume, clogging is hardly caused.

In the present exemplary embodiment, the average particle size of the particle is a value measured using a Coulter counter, TA-II Model (manufactured by Beckman Coulter Inc.). In that case, the average particle size of the particle is measured using an optimal aperture depending upon the particle size level of the particle. Also, in the case where the particle size of the particle is not more than 5 μm, the particle size may be measured using a laser diffraction scattering particle size distribution analyzer (LA-920, manufactured by Horiba, Ltd.). The particle size of the particle expresses a volume average particle size unless otherwise indicated.

The present exemplary embodiment is hereunder described in more detail with reference to the accompanying drawings. Needless to say, it should not be construed that the present exemplary embodiment is limited to the following embodiments.

FIGS. 1 to 3 are each a schematic sectional view showing an embodiment of the micro fluidic device of the present exemplary embodiment.

A micro fluidic device 10 shown in FIG. 1 includes two base materials 12a and 12b and a separation membrane 14. A channel L₁ 16 comes into contact with a part of an upper surface 22 of the separation membrane 14; a channel L₂ 18 comes into contact with each side surface 26 of the separation membrane 14; and a lower surface 24 of the separation membrane 14 is blocked by the base material 12b. Also, a sealing member 20 is embedded in a part between the two base materials 12a and 12b.

In the micro fluidic device 10 shown in FIG. 1, a fluid sent from a feed port X₁ (not illustrated) enters the separation membrane 14 from the upper surface 22 of the separation membrane 14 through the channel L₁ 16 and flows within the separation membrane 14 in the surface direction of the membrane, and it is then sent to the channel L₂ 18 from the side surface 26 of the separation membrane 14 and discharged from the discharge port Y, (not illustrated).

Also, the micro fluidic device 10 shown in FIG. 2 is the same as the micro fluidic device shown in FIG. 1, except that the position of the sealing member is different. The sealing member 20 is embedded in a part between the base material 12a and the separation membrane 14.

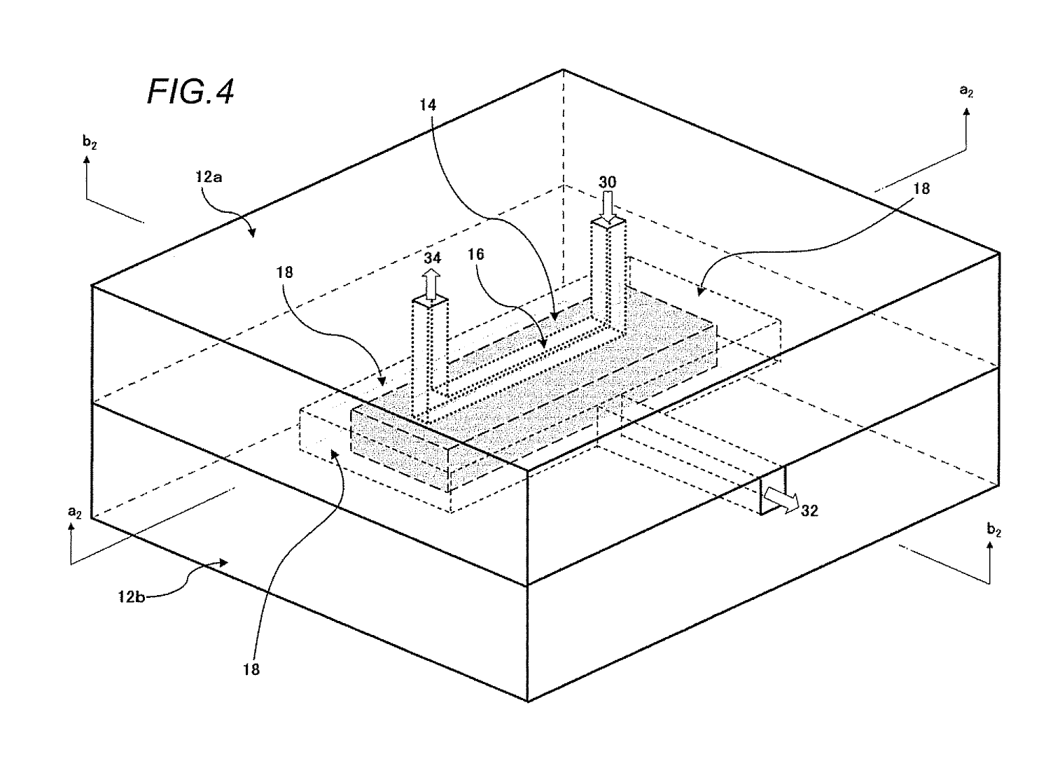

FIG. 4 is a schematic view showing a further other embodiment of the micro fluidic device of the present exemplary embodiment.

Here, FIGS. 1 and 2 are each a schematic sectional view cut by a baby plane not going through a discharge port Y₁ 32 of the micro fluidic device shown in FIG. 4. Though no description is given in FIG. 4, a device set outside the channel L₂ 18 in a state where the sealing member 20 is sandwiched with the base materials 12a and 12b is corresponding to FIG. 1, and a device set in a state where the sealing member 20 is sandwiched with the separation member 14 and the base material 12a is corresponding to FIG. 2.

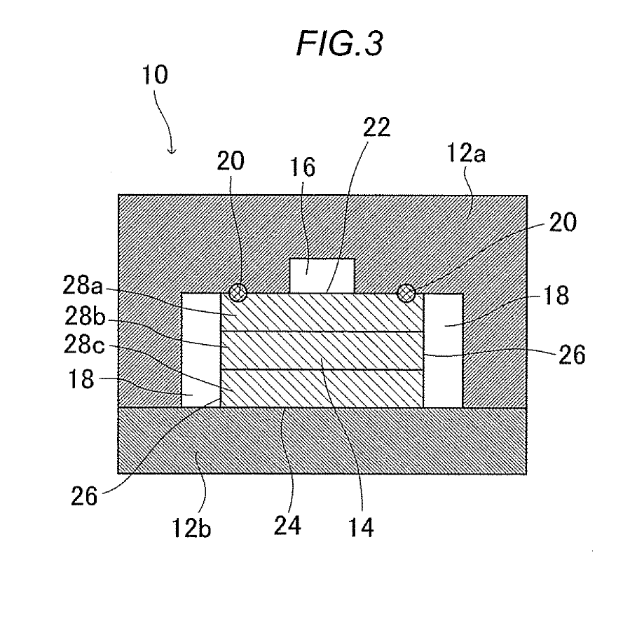

The micro fluidic device 10 shown in FIG. 3 includes the two base materials 12a and 12b and the separation membrane 14 composed of three membranes 28a, 28b and 28c. The channel L₁ 16 comes into contact with a part of the upper surface 22 of the separation membrane 14; the channel L₂ 18 comes into contact with each side surface 18 of the separation membrane 14; and the lower surface 24 of the separation membrane 14 is blocked by the substrate 12b. Also, the sealing member 20 is embedded in a part of the base material 12a and the separation membrane 14.

In the micro fluidic device shown in FIG. 3, a fluid sent from the feed port X₁ (not illustrated) enters the membrane 28a from the upper surface 22 of the separation membrane 14 through the channel L₁ 16. The fluid which has entered the membrane 28a successively flows into the membrane 28b and the membrane 28c. Also, the fluid flows in the surface direction of the membrane in each of the membranes 28a, 28b and 28c, and it is then sent to the channel L₂ 18 from the side surface 26 of the separation membrane 14 and discharged from the discharge port Y₁ (not illustrated).

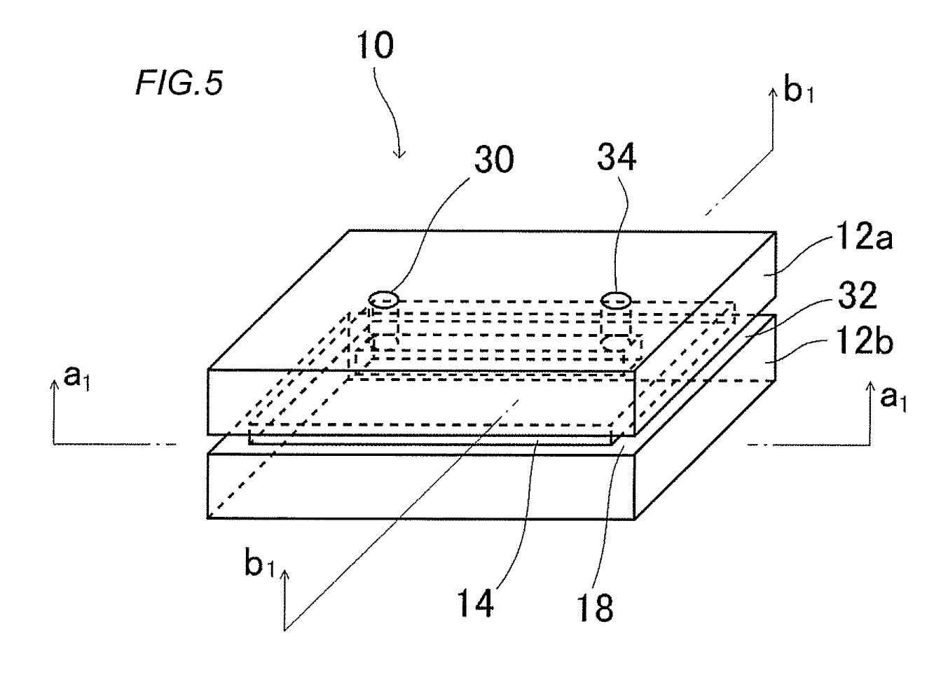

FIG. 5 is a schematic view showing a further other embodiment of the micro fluidic device of the present exemplary embodiment.

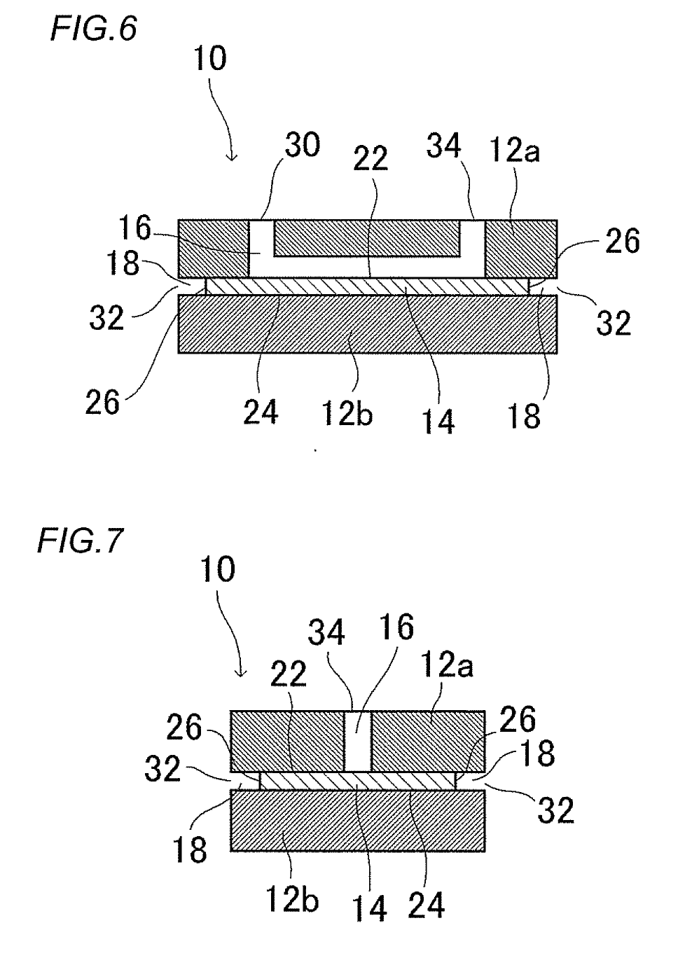

FIG. 6 is a schematic sectional view cut along an a₁-a₁ plane going through a central portion of the micro fluidic device shown in FIG. 5.

FIG. 7 is a schematic sectional view cut along a b₁-b₁ plane going through a discharge port Y₂ 34 of the micro fluidic device shown in FIG. 5.

The micro fluidic device shown in FIG. 5 includes the two base materials 12a and 12b whose external shape is of a substantially rectangular parallelepiped and the separation membrane 14 having a shape of rectangular parallelepiped. The base material 12a and the base material 12b are fixed by a fixing: member (not illustrated) in a state where the separation membrane 14 is sandwiched therewith. The channel L₁ 16 connected to a feed port X₁ 30 and a discharge port Y₂ 34 comes into contact with a part of the upper surface 22 of the separation membrane 14; the channel L₂ 18 comes into contact with the entire periphery of the side surface 18 of the separation membrane 14; and the lower surface 24 of the separation membrane 14 is blocked by the base material 12b. Also, the whole of a space between an end of the base material 12a on all sides and an end of the base material 12b on all sides is the discharge port Y₁ 32 corresponding to a thickness of the separation membrane 14.

In the micro fluidic device shown in FIG. 5, a fluid sent from the feed port X₁ 30 enters the separation membrane 14 from the upper surface 22 of the separation membrane 14 through the channel L₁ 16 and flows within the separation membrane 14 on all sides in the surface direction of the membrane, and it is then sent to the channel L₂ 18 from the entire periphery of the side surface 26 of the separation membrane 14 and discharged from the discharge port Y₁ 32. Also, of the fluids which have been sent from the feed port X₁ 30, the fluid which has not passed through the separation membrane 14 flows in the channel L₁ 16 as it is and is discharged from the discharge port Y₂ 34.

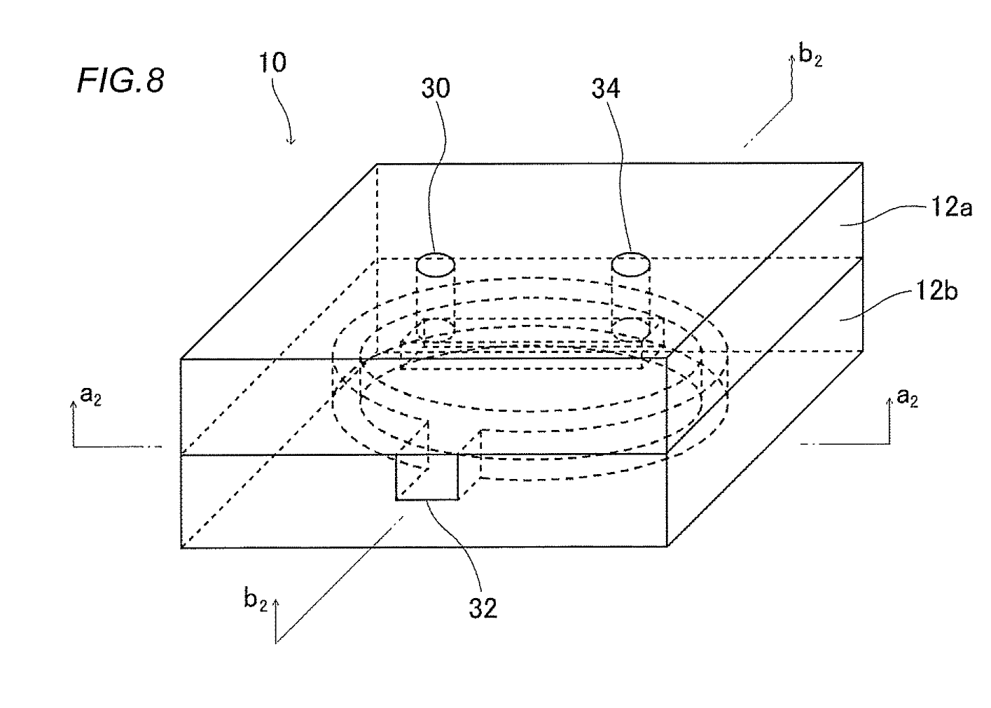

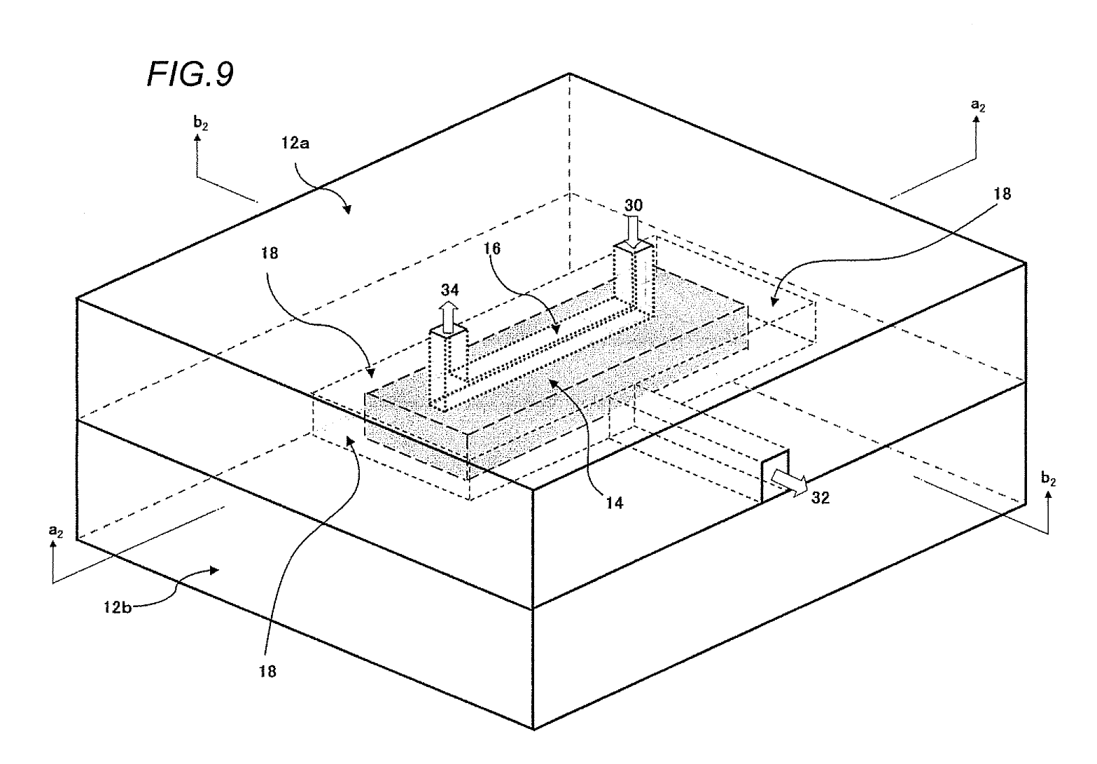

FIGS. 8 and 9 are each a schematic view showing a further other embodiment of the micro fluidic device of the present exemplary embodiment.

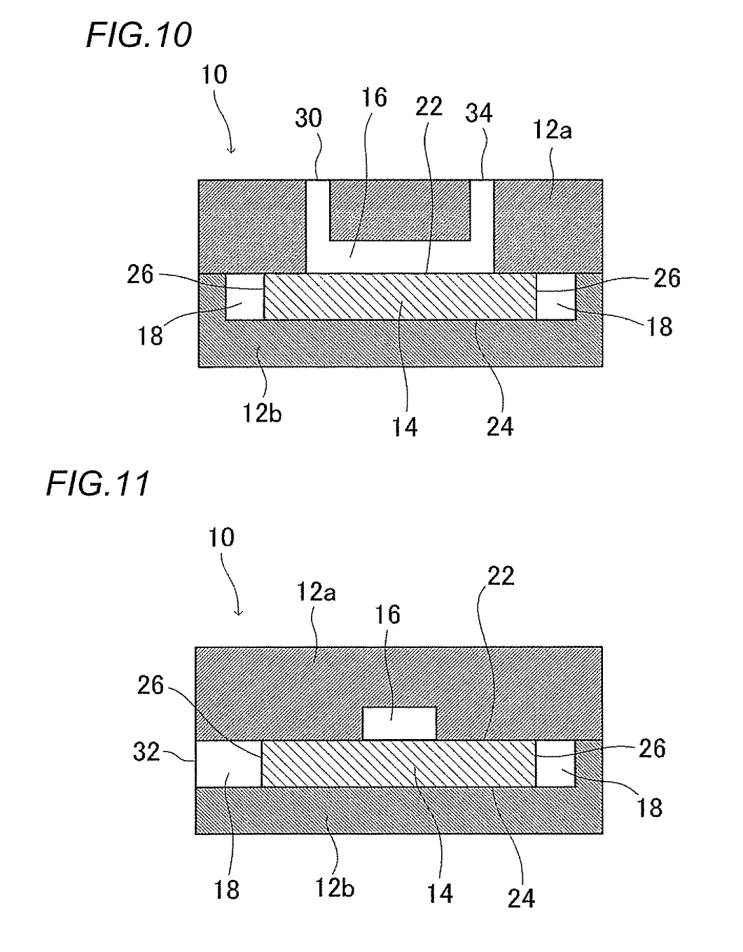

FIG. 10 is a schematic sectional view cut along an a₂-a₂ plane going through a central portion of the micro fluidic device shown in each of FIGS. 8 and 9.

FIG. 11 is a schematic sectional view cut alone a b₂-b₂ plane going through a discharge port Y₁ 32 of the micro fluidic device shown in each of FIGS. 8 and 9.

The micro fluidic device shown in FIG. 8 includes the two base materials 12a and 12b whose external shape is of a substantially rectangular parallelepiped and the separation membrane 14 having a columnar shape. The base material 12a and the base material 12b are fixed by a fixing member (not illustrated) in a state where the separation membrane 14 is sandwiched therewith. The channel L₁ 16 connected to the feed port X₁ 30 and the discharge port Y₂ 34 comes into contact with a part of the upper surface 22 of the separation membrane 14; the channel L₂ 18 comes into contact with the entire periphery of the side surface 26 of the separation membrane 14 having a columnar shape and is formed in a substantially doughnut form; and the lower surface 24 of the separation membrane 14 is blocked by the base material 12b. Also, the discharge Y₁ 32 is formed in the base material 12b and linked to the foregoing channel in a substantially doughnut form, thereby forming the channel L₂ 18.

In the micro fluidic device shown in FIG. 8, a fluid sent from the feed port X₁ 30 enters the separation membrane 14 from the upper surface 22 of the separation membrane 14 through the channel L₁ 16 and flows within the separation membrane 14 in the surface direction of the membrane, and it is then sent to the channel L₂ 18 from the entire periphery of the side surface 26 of the separation membrane 14 and discharged from the discharge port Y₁ 32. Also, of the fluids which have been sent from the feed port X₁ 30, the fluid which has not passed through the separation membrane 14 flows in the channel L₁ 16 as it is and is discharged from the discharge port Y₂ 34.

The micro fluidic device shown in FIG. 9 includes the two base materials 12a and 12b whose external shape is of a substantially rectangular parallelepiped and the separation membrane 14 having a shape of rectangular parallelepiped. The base material 12a and the base material 12b are fixed by a fixing member (not illustrated) in a state where the separation membrane 14 is sandwiched therewith. The channel L₁ 16 connected to the feed port X₁ 30 and the discharge port Y₂ 34 comes into contact with a part of the upper surface 22 of the separation membrane 14; the channel L₂ 18 is formed while coming into contact with the entire periphery of the side surface of the separation membrane 14 having a shape of rectangular parallelepiped; and the lower surface 24 of the separation membrane 14 is blocked by the base material 12b. Also, the discharge Y₁ 32 is formed in the base material 12b and linked to the channel L₂ 18.

In the micro fluidic device shown in FIG. 9, a fluid sent from the feed port X₁ 30 enters the separation membrane 14 from the upper surface 22 of the separation membrane 14 through the channel L₁ 16 and flows within the separation membrane 14 in the surface direction of the membrane, and it is then sent to the channel L₂ 18 from the entire periphery of the side surface of the separation membrane 14 and discharged from the discharge port Y₁ 32. Also, of the fluids which have been sent from the feed port X₁ 30, the fluid which has not passed through the separation membrane 14 flows in the channel L₁ 16 as it is and is discharged from the discharge port Y₂ 34.

As shown in FIGS. 1 to 11, the micro fluidic device of the present exemplary embodiment may be simply fabricated by processing the respective base materials and the separation membrane into prescribed shapes, sandwiching the separation membrane between the base material and the base material and bonding and/or fixing them by a known bonding method and/or fixing method. Also, the micro fluidic device of the present exemplary embodiment may be simply fabricated without necessity for registering a position at which the separation membrane is sandwiched strictly (for example, in a micron order).

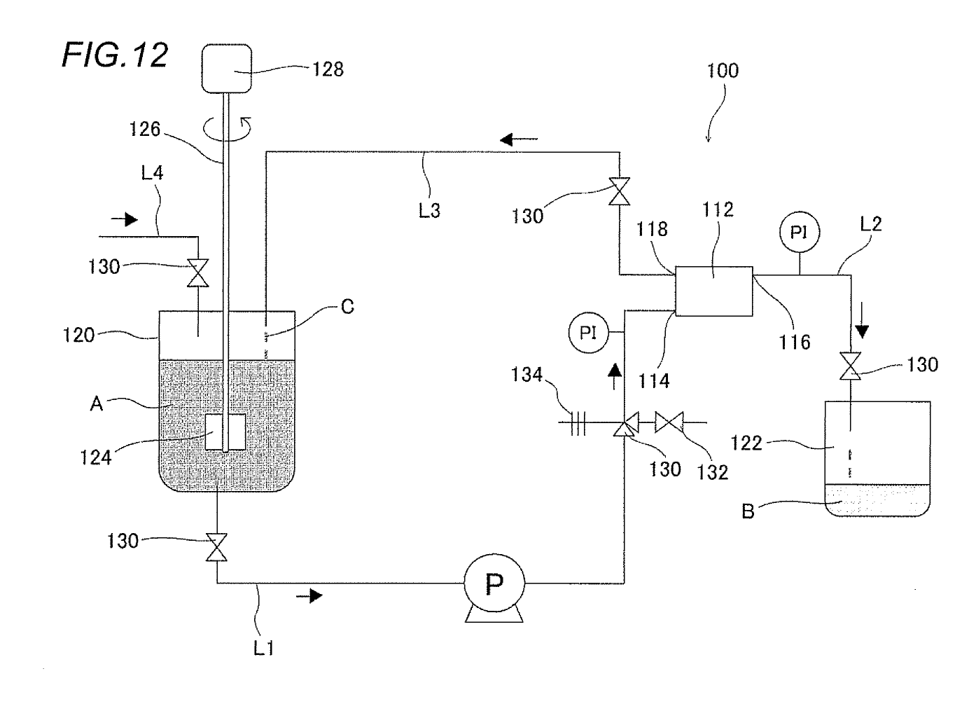

FIG. 12 is a conceptual view of an embodiment of the separation apparatus of the present exemplary embodiment.

A separation apparatus 100 shown in FIG. 12 includes a micro fluidic device 112 of the present exemplary embodiment. The micro fluidic device 112 includes a feed port X₁ 114, a discharge port Y₁ 116 and a discharge port Y₂ 118. A fluid A in a container 120 is fed into the feed port X₁ 114 from a lower part of the container 120 through a channel L₁. A channel L2 is connected to the discharge port Y₁ 116, through which a separated fluid B may be stored in a container 122. Also, a channel L3 is connected to the discharge port Y₂ 118, through which a separated fluid C may be returned to the container 120.

The separation apparatus 100 shown in FIG. 12 is a separation apparatus capable of separating the fluid A into the fluid B and the fluid C using the micro fluidic device 112 of the present exemplary embodiment. The feed port X₁ 114 and the discharge port Y₁ 116 are connected to each other through a separation membrane, and the feed port X₁ 114 and the discharge port Y₂ 118 are connected to each other without through a separation membrane.

The container 120 may be provided with a stirring unit and the like. For example, as shown in FIG. 12, there may be exemplified a motor 128 provided with a stirring blade 124 and a rotation axis 126, and the like.

Also, the container 120 may be provided with a feed unit and the like. In the separation apparatus shown in FIG. 12, a desired fluid or solid or the like may be fed from a channel L4.

Each of the channels L1 to L4 may be provided with a pressure regulating unit. For example, as shown in FIG. 12, the channel L1 is provided with a pump P, a pressure detector PI, a valve 130, a safety valve 132 and a back pressure valve 134. Also, each of the channels L2 to L4 is provided with the valve 130, and the channel L2 is further provided with the pressure detector PI.

As shown in FIG. 12, when the separation apparatus of the present exemplary embodiment is a separation apparatus in which the feed port X₁ and the discharge port Y₂ of the micro fluidic device of the present exemplary embodiment are connected to each other, thereby enabling a fluid to circulate therethrough, a fluid containing a material to be separation may be repeatedly sent to the micro fluidic device, and excellent separation precision and separation stability are revealed. Therefore, such is preferable.

### Examples

The present exemplary embodiment is more specifically described below with reference to the following Examples and Comparative Examples, but it should not be construed that the present exemplary embodiment is limited to the following Examples. In the following Examples and Comparative Examples, the term “part” refers to “part by weight”.

### Example 1

Classification of a styrene-n-butyl acrylate resin fine particle dispersion (composition ratio: 75/25, weight average molecular weight: 35,000) is carried out. A specific gravity of the resin is 1.08; fine particles having an average particle size of 5 μm, 10 μm and 20 μm are mixed in a proportion of 8/1/1 in terms of a volume ratio; and the mixture is subjected to a water dispersion treatment with ion exchanged water to prepare a resin fine particle dispersion A having a concentration of 2% by volume.

A particle size distribution data of the resin fine particle dispersion A measured by a Coulter counter, TA-II Model (manufactured by Beckman Coulter Inc.) displays particle size distribution having a large peak at 5 μm and two small peaks at 10 μm and 20 μm.

Using the micro fluidic device shown in FIGS. 1 and 4, the resin fine particle dispersion A is subjected to a separation and concentration treatment by the separation apparatus shown in FIG. 12.

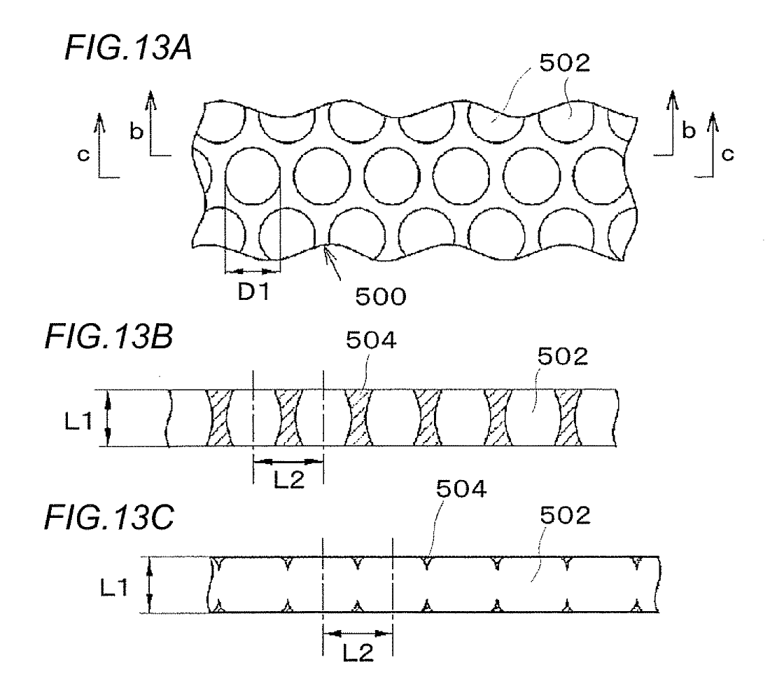

In the micro fluidic device used in Example 1 and shown in FIGS. 1 and 4, a polycarbonate-made honeycomb film having a pore size of 15 μm as shown in FIGS. 13A to 13C is used as a separation membrane. A Harvard's syringe pump is used as a pump; a small-sized magnetic stirrer of 2 mm×2 mm×5 mm is put in the syringe; and the resin fine particle dispersion A is sent at a flow rate of 10 mL/h while preventing sedimentation of the particle from occurring with stirring by the magnet rotated by a small-sized motor from the outside of the syringe.

As a result of measurement of particle size distribution of the resin fine particle dispersion recovered in the container 122 shown in FIG. 12 by a Coulter counter, TA-II Model, particle size distribution not having a particle peak at 20 μm and having two particle peaks of a small peak at 10 μm and a large peak at 5 μm is displayed.

### Example 2

The resin particle dispersion A is subjected to a separation and concentration treatment using the separation apparatus shown in FIG. 12.

In the micro fluid device used in Example 2 and shown in FIG. 3, a separation membrane obtained by superimposing and setting three separation membranes having a pore size of 15 μm as shown in FIGS. 13A to 13C is used. The resin particle dispersion A is sent while stirring the inside of a syringe using the same Harvard's syringe pump as in Example 1.

As a result of measurement of particle size distribution of the resin fine particle dispersion recovered in the container 122 shown in FIG. 12 by a Coulter counter, TA-II Model, particle size distribution not having a particle peak at 20 μm and having two particle peaks of a small peak at 10 μm and a large peak at 5 μm is displayed.

### Example 3

Classification of a styrene-n-butyl acrylate resin fine particle dispersion (composition ratio: 75/25, weight average molecular weight: 35,000) is carried out. A specific gravity of the resin is 1.08, fine particles having an average particle size of 2 μm and 20 μm are mixed in a proportion of 9/1 in terms of a volume ratio; and the mixture is subjected to a water dispersion treatment with ion exchanged water to prepare a resin fine particle dispersion B having a concentration of 2% by volume.

A particle size distribution data of the resin fine particle dispersion B measured by a Coulter counter, TA-II Model displays particle size distribution having a large peak at 2 μm and a small peak at 20 μm.

Using the micro fluidic device shown in FIGS. 2 and 4, the resin fine particle dispersion B is subjected to a separation and concentration treatment by the separation apparatus shown in FIG. 12.

In the micro fluidic device used in Example 3 and shown in FIGS. 2 and 4, a polycarbonate-made honeycomb film having a filter pore size of 15 μm as shown in FIGS. 13A to 13C is used as a separation membrane. The resin particle dispersion B is sent at a flow rate of 10 mL/h while stirring the inside of a syringe using the same Harvard's syringe pump as in Example 1.

As a result of measurement of particle size distribution of the resin fine particle dispersion having passed through the honeycomb film and recovered in the container 122 shown in FIG. 12 by a Coulter counter, TA-II Model, particle size distribution not having a particle peak at 20 μm and having only a peak at 2 μm is displayed.

### Example 4

A separation test is carried out using two types of resin particles having a different particle size (crosslinked polystyrene resin particles SX-130H (average particle size: 1.3 μm) and SX-500H (average particle size: 5.0 μm), all of which are manufactured by Soken Chemical & Engineering Co., Ltd., density, 1.05 g/cm³). First of all, crosslinked polystyrene resin particles of 1.3 μm and 5.0 μm are dispersed in a mixing ratio of 50/50 (by weight) in water to prepare a resin particle dispersion C having a solids content of 0.5%. The resin particle dispersion C is subjected to a separation treatment in the same manner as in Example 1 by the separation apparatus shown in FIG. 12 using the micro fluidic device shown in FIGS. 1 and 4. A cellulose acetate type membrane filter (C300A, manufactured by Advantec MFS, Inc.) having a pore size of 3.0 μm and a thickness of 135 μm is used as the separation membrane in place of the polycarbonate-made honeycomb film used in Example 1. A Harvard's syringe pump is used as a pump; a small-sized magnetic stirrer of 2 mm×2 mm×5 mm is put in the syringe; and the resin fine particle dispersion B is sent at a flow rate of 10 mL/h while preventing sedimentation of the particle from occurring with stirring by the magnet rotated by a small-sized motor from the outside of the syringe.

As a result of measurement of particle size distribution of the resin fine particle dispersion recovered in the container 122 shown in FIG. 12 by a Coulter counter, TA-II Model, particle size distribution having only a particle peak at 1.3 μm in average particle size is displayed.

### Comparative Example 1

A separation apparatus is fabricated according to a method disclosed in Example 2 of JP-A-2006-95515.

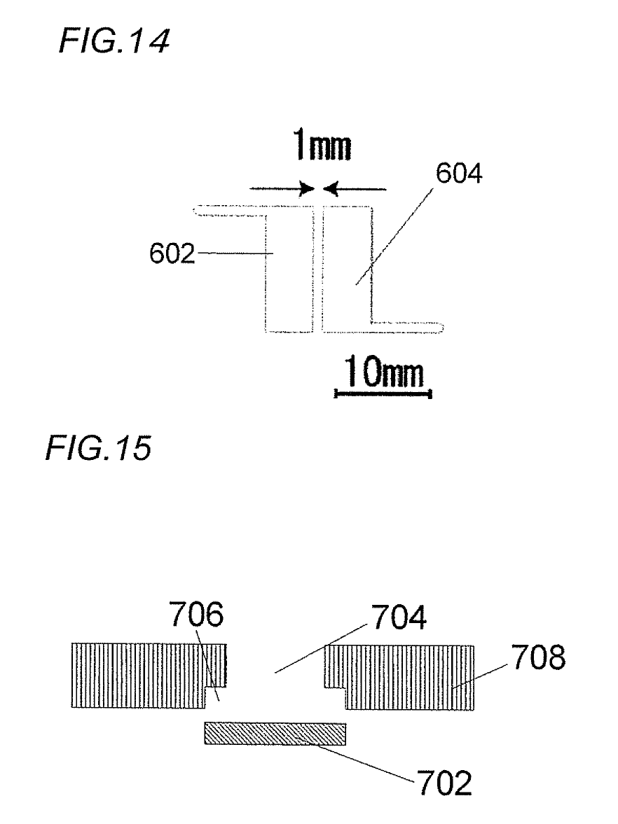

Using a pattern shown in FIG. 14, a groove (recessed part) having a depth of about 0.5 mm is prepared in a polymethyl methacrylate resin (PMMA) plate by means of milling using an end mill having a diameter of 1 mm, and a through-hole having a diameter of 2 mm is provided in an end thereof by means of drilling. The polycarbonate-made honeycomb film having a filter pore size of 25 μm and shown in FIGS. 13A to 13C is sandwiched with this grooved PMMA plate and a non-grooved PMMA plate and sealed by a hot press. This is disposed in two polycarbonate-made holders having a thickness of 10 mm, followed by adequately fastening by screws at the four corners of the holders. A sample discharge port of the fabricated separation apparatus is connected to a syringe pump (PHD2000, manufactured by Harvard) with a polyetheretherketone resin (PEEK) tube; the PEEK tube on the side of a sample inlet is inserted into a liquid sink of the styrene-n-butyl acrylate resin fine particle dispersion A used in Example 1 (average particle size: 5 μm/10 μm/20 μm=8/1/1 in terms of a volume ratio); and liquid sending is carried out in a suction mode. As a result, clogging is immediately caused on the upstream side, and liquid sending and filtration are difficult.

### Comparative Example 2

A separation apparatus is fabricated according to a method disclosed in Example 4 of JP-A-2006-61870.

An acrylic resin plate having a thickness of 1 mm (DELAGLAS A, manufactured by Asahi Kasei Corporation) is cut out in a size of slide glass, and a through-hole is provided in its central portion by means of drilling. This plate is hot pressed using a die having plate-shaped protrusions with a height of 20 μm. A schematic view of a sectional shape thereof is shown in FIG. 15. The polycarbonate-made honeycomb film having a filter pore size of 25 μm and shown in FIGS. 13A-13C is placed in a portion of difference in level by press molding, and an extremely small amount of methylene chloride is coated only in the surroundings of the honeycomb film, whereby the honeycomb film is allowed to adhere to the portion of difference in level. There is thus formed a structure which is substantially free from a difference in level. Furthermore, the structural material is combined with a lower plate and adequately fastened by screws. A sample discharge port of the fabricated separation apparatus is connected to a syringe pump (PHD2000, manufactured by Harvard) with a PEEK tube; the PEEK tube on the side of a sample inlet is inserted into a liquid sink of the styrene-n-butyl acrylate resin fine particle dispersion A used in Example 1 (average particle size: 5 μm/10 μm/20 μm=8/1/1 in terms of a volume ratio); and liquid sending is carried out in a suction mode. As a result, the honeycomb film is broken so that filtration is difficult.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A micro fluidic device comprising:
a separation membrane that has an upper surface and a lower surface opposing to each other and a side surface;
a plurality of base materials that sandwiches the separation membrane;
a first channel and a second channel that are partitioned from each other by the separation membrane;
a first feed port that is connected to the first channel; and
a first discharge port that is connected to the second channel, wherein
the first channel comes into contact with at least a part of the upper surface and the lower surface of the separation membrane,
the second channel comes into contact with at least a part of the side surface of the separation membrane, and
a fluid is movable in a surface direction within the separation membrane.

2. The micro fluidic device according to claim 1, wherein the first channel comes into contact with at least a part of the upper surface or the lower surface of the separation membrane, and
of the upper surface or the lower surface of the separation membrane, the opposite surface to the surface with which the first channel comes into contact is blocked.

3. The micro fluidic device according to claim 2, wherein a blocked portion in the opposite surface to the surface with which the first channel comes into contact is a portion of the opposite surface corresponding to the portion with which the first channel comes into contact and a neighborhood of the portion of the opposite surface or is a whole of the opposite surface.

4. The micro fluidic device according to claim 2, wherein, a blocked portion is a whole of the opposite surface.

5. The micro fluidic device according to claim 1, further comprising:
a second discharge port that is connected to the first channel.

6. The micro fluidic device according to claim 1, wherein the separation membrane is a laminated separation membrane obtained by laminating two or more membranes.

7. The micro fluidic device according to claim 1 further comprising:
a second feed port that is connected to the second channel.

8. The micro fluidic device according to claim 1 wherein the separation membrane has an opening in a side surface direction thereof, and
the separation membrane includes at least one of mesh-shaped separation membranes woven with plastic fibers or metallic fibers and plastic-made honeycomb films by self organization, ceramic-made, or paper-made separation membranes.

9. The micro fluidic device according to claim 1, wherein, in the upper surface and the lower surface of the separation membrane, the surface through which the fluid passes is free from irregularities;

10. The micro fluidic device according to claim 1, wherein the side surface of the membrane has a larger average pore size than at least one of the upper surface and the lower surface of the membrane through which a fluid passes.

11. The micro fluidic device according to claim 1, further comprising:
one or more other channels than the first channel and the first channel.

12. A separation apparatus that includes a micro fluidic device according to claim 1.
